(19) United States
(12) Patent Application Publication
(10) Pub. No.: US 2023/0409978 A1
(43) Pub. Date: Dec. 21, 2023

(54) INFORMATION PROCESSING APPARATUS, INFORMATION PROCESSING METHOD, AND NON-TRANSITORY COMPUTER READABLE MEDIUM

(71) Applicant: Rakuten Group, Inc., Tokyo (JP)

(72) Inventors: Prince AGARWAL, Tokyo (JP); Mayank Bansal, Tokyo (JP); Gaurav Parikh, Tokyo (JP)

(73) Assignee: Rakuten Group, Inc., Tokyo (JP)

(21) Appl. No.: 18/319,017

(22) Filed: May 17, 2023

(30) Foreign Application Priority Data
Jun. 16, 2022 (JP) 2022-096992

(51) Int. Cl. G06N 20/00; G06N 5/022

(52) U.S. Cl. CPC G06N 20/00; G06N 5/022

(57) ABSTRACT

An information processing apparatus acquires data on positions of a user accompanying movement of the user, acquires a user feature representing a feature of the user, generates a user vector representing a feature of the movement of the user based on the position data and the user feature, generates a sequence vector representing a sequence of locations visited by the user based on the position data; and predicts a next location that the user will visit based on the user victor and the sequence vector through machine learning.

### TECHNICAL FIELD

The present invention relates to an information processing apparatus, an information processing method, and a non-transitory computer readable medium, and particularly to a technique for predicting user behavior.

### BACKGROUND ART

A conventional technique for acquiring position information of a terminal device and detecting the behavior of a user of the terminal device based on the position information is known. For example, JP 2015-37244A discloses a technique in which an access point in a wireless LAN acquires, from a terminal device, position information of the terminal device and detects that the user of the terminal device has visited a predetermined store.

JP 2015-140929A is an example of related art.

### SUMMARY OF THE INVENTION

In the technique disclosed in JP 2015-37244A, locations visited by the user of the terminal device can be determined based on the position information of the terminal device. In other words, the technique according to JP 2015-37244A can detect locations that the user has visited thus far (i.e., the locations visited in the past and currently being visited). However, this technique cannot predict a location that the user will visit next (i.e., the next location to visit).

In view of the above problem, the present disclosure provides a technique for predicting the next location a user will visit.

In order to solve the above problem, one aspect of the information processing apparatus according to the present invention includes: a position data acquisition unit configured to acquire data on positions of a user accompanying movement of the user; a feature acquisition unit configured to acquire a user feature representing a feature of the user; a user vector generation unit configured to generate a user vector representing a feature of the movement of the user based on the position data and the user feature; a sequence vector generation unit configured to generate a sequence vector representing a sequence of locations visited by the user based on the position data; and a prediction unit configured to predict a next location that the user will visit based on the user victor and the sequence vector through machine learning.

In order to solve the above problem, one aspect of the information processing method according to the present invention includes: acquiring data on positions of a user accompanying movement of the user; acquiring a user feature representing a feature of the user; generating a user vector representing a feature of the movement of the user based on the position data and the user feature; generating a sequence vector representing a sequence of locations visited by the user based on the position data; and predicting a next location that the user will visit based on the user victor and the sequence vector through machine learning.

In order to solve the above problem, one aspect of the program according to the present invention is an information processing program for causing a computer to execute information processing, the program causing the computer to execute: position data acquisition processing for acquiring data on positions of a user accompanying movement of the user; feature acquisition processing for acquiring a user feature representing a feature of the user; user vector generating processing for generating a user vector representing a feature of the movement of the user based on the position data and the user feature; sequence vector generation processing for generating a sequence vector representing a sequence of locations visited by the user from the position data; and prediction processing for predicting a next location that the user will visit based on the user victor and the sequence vector through machine learning.

According to the present invention, a technique is provided for predicting the next location that a user will visit.

The objects, aspects, and effects of the present invention described above and objects, aspects and effects of the present invention not described above can be understood by a person skilled in the art based on the following modes for carrying out the invention by referring to the accompanying drawings and the description of the claims.

### BRIEF DESCRIPTION OF THE DRAWINGS

FIG. 1 shows a configuration example of an information processing system.

FIG. 2 shows an example of a functional configuration of an information processing apparatus 10 according to an embodiment.

FIG. 3 shows an example of geodata.

FIG. 4 shows a hardware configuration example of an information processing apparatus 10 and a user device 11.

FIG. 5 is a flowchart showing a procedure for generating user vectors.

FIG. 6A shows a conceptual diagram of a procedure for generating region-of-interest vectors.

FIG. 6B shows a conceptual diagram of a procedure for generating location-of-interest vectors.

FIG. 6C shows a conceptual diagram of a procedure for generating transportation vectors.

FIG. 6D shows a conceptual diagram of a procedure for generating user vectors.

FIG. 7 shows a conceptual diagram of a procedure for generating sequence vectors.

FIG. 8 shows a conceptual diagram of a next location prediction model.

FIG. 9 is a flowchart showing processing for predicting the next location a user will visit.

### EMBODIMENTS OF THE INVENTION

Hereinafter, an embodiment for implementing the present invention will be described in detail with reference to the accompanying drawings. Constituent elements disclosed hereinafter that have the same function as each other are denoted by identical reference signs, and description thereof is omitted. Note that the embodiment disclosed hereinafter is an example serving as a means of realizing the present invention, the embodiment is to be amended or modified as appropriate according to the configuration of the device to which the present invention is applied and various conditions, and the present invention is not limited to the following embodiment. Also, not all combinations of features described in the present embodiment are essential for the solving means of the present invention.

### Configuration Example of Information Processing System

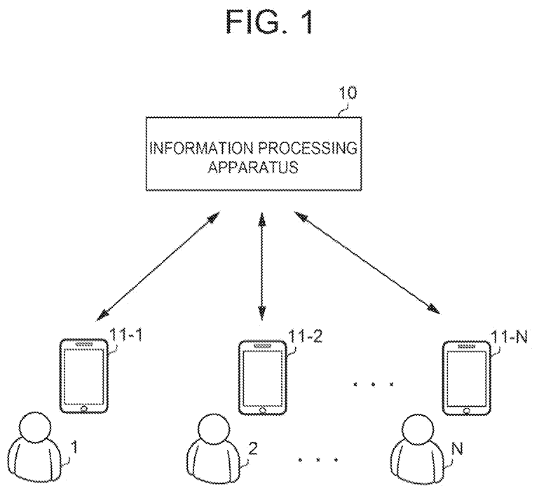

FIG. 1 shows an example of a configuration of an information processing system according to the present embodiment. In one example, as shown in FIG. 1, the present information processing system includes an information processing apparatus 10, and a plurality of user devices 11-1 to 11-N(N>1) used by any plurality of users 1 to N. Note that in the following description, the user devices 11-1 to 11-N can be referred to collectively as user devices 11 unless otherwise specified. Also, in the following description, the terms “user device” and “user” can be used synonymously.

The user device 11 is, for example, a device such as a smartphone or a tablet, and can communicate with the information processing apparatus 10 via a public network such as LTE (Long Term Evolution) or a wireless communication network such as a wireless LAN (Local Area Network). The user device 11 has a display unit (display screen) such as a liquid crystal display, and each user can perform various operations through a GUI (Graphic User Interface) installed in the liquid crystal display. The operations include various operations performed with a finger or a stylus on content such as images displayed on the screen, such as a tap operation, a slide operation, or a scroll operation.

Note that the user device 11 is not limited to a device of the form shown in FIG. 1, and may also be a device such as a tablet terminal or a laptop PC. Also, the user device 11 may include a display screen separately.

The user device 11 can use a web service (Internet-related service) provided from the information processing apparatus 10, or from another device (not shown) via the information processing apparatus 10. The web service can include an online mall, an online supermarket, or a service relating to communication, finance, real estate, sports, or travel, which are provided via the Internet. In order to use the web service, the user device 11 can register the address of the user or the name of the user, the number of a credit card owned by the user, demographic information of the user (demographic user attributes such as sex, age, residential area, occupation, and family composition), and the like.

Also, the user device 11 can perform positioning calculation based on signals or the like received from GPS (Global Positioning System) satellites (not shown), generate data on positions of the user (position data) accompanying the movement of the user, such as latitude, longitude, and altitude, obtained through the calculation. The user device 11 can send (transmit) the position data to the information processing apparatus 10. The user device 11 can periodically send position data to the information processing apparatus 10.

Functional Configuration of Information Processing Apparatus 10

The information processing apparatus 10 according to the present embodiment first acquires position data and user features from the user devices 11-1 to 11-N. The user features will be described below. The information processing apparatus 10 generates, based on the position data, geographic data (hereinafter referred to as geodata) that includes information on the position, and generates a user vector indicating the feature of the movement (behavior) of each user from the geodata and the user feature. In the present embodiment, a user vector is comprised of a combination of three types of feature vectors. The information processing apparatus 10 trains a next location prediction model 111 based on the user vectors. In addition, the information processing apparatus 10 uses the trained next location prediction model 111 to predict the location that a user will visit next (the next location to visit) based on the position data obtained from the user. Note that the term “vector” as used in the present embodiment refers to a feature amount or a feature value.

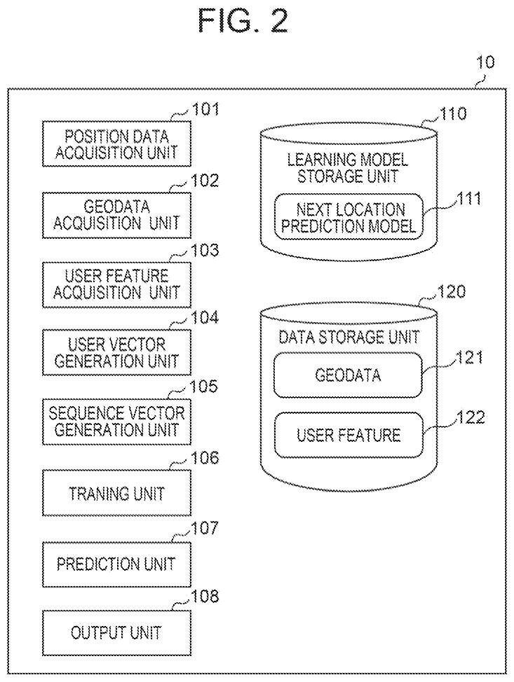

FIG. 2 is a block diagram showing an example of a functional configuration of the information processing apparatus 10 according to the present embodiment.

The information processing apparatus 10 shown in FIG. 2 includes a position data acquisition unit 101, a geodata acquisition unit 102, a user feature acquisition unit 103, a user vector generation unit 104, a sequence vector generation unit 105, a training unit 106, a prediction unit 107, an output unit 108, a learning model storage unit 110, and a data storage unit 120. The learning model storage unit 110 is configured to store the next location prediction model 111. Also, the data storage unit 120 is configured to store geodata 121 and user features 122.

The position data acquisition unit 101 acquires position data from each of the user devices 11-1 to 11-N. The position data includes latitude and longitude data obtained through positioning calculation in the user device 11. A user ID is associated with the position data. The user ID is an identifier for identifying the user, and, for example, the ID registered by the user to use the web service may be used. Alternatively, the user ID may be an ID corresponding to the source address of the user device 11 that transmitted the position data. The user device 11 can periodically transmit position data to the information processing apparatus 10, allowing the position data acquisition unit 101 to periodically obtain position data.

The geodata acquisition unit 102 uses the position data acquired by the position data acquisition unit 101 to generate and acquire geodata. Map information is used to generate geodata. The map information can include the names of locations, land use types, such as park, school, and station (hereinafter referred to as types), and the addresses of the locations. First, the geodata acquisition unit 102 determines the locations where the user has stayed for certain periods of time (hereinafter referred to as visited locations) according to the movement of latitude and longitude, which constitutes the position data. The geodata acquisition unit 102 generates location information, indicating the names and the types of the visited locations based on the visited locations and the map information. That certain period of time may be set as appropriate. The geodata acquisition unit 102 additionally generates the dates and times when the user enters (in) and leaves (out) the visited locations, i.e., the start and end dates and times of the certain periods of time. The geodata acquisition unit 102 generates geodata that includes position data, location information, dates and times (in) and dates and times (out) of the visited locations.

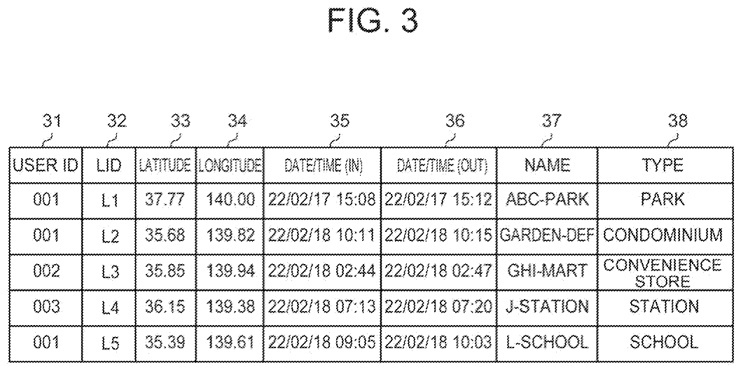

An example of geodata is shown in FIG. 3. In FIG. 3, the user ID 31 is an identifier of the user. In the example in FIG. 3, the user ID 31 consists only of numbers, but may be composed of any combination of identifiable letters and numbers.

An LID (Location ID) 32 is an ID assigned to a latitude 33 and a longitude 34 of each visited location (the location where the user has stayed for a certain period of time). The same LID 32 can be assigned to locations that can be recognized as the same locations even if their latitude 33 and longitude 34 do not fully match (for example, within certain ranges of latitude and longitude).

The latitude 33 and the longitude 34 are the latitude and the longitude, respectively, of the visited locations corresponding to LIDs 32. The latitude 33 and the longitude 34 are acquired from the position data acquired by the position data acquisition unit 101. In the example in FIG. 3, the latitude 33 and the longitude 34 are data to the second decimal place, but the precision of the data may be set as appropriate.

The dates and times (in) 35 and the dates and times (out) 36 are the dates and times when the user entered and left the visited locations, respectively. In the example in FIG. 3, the dates and times (in) 35 and the dates and times (out) 36 are represented as year/month/day and time, but this is only one example. For example, the dates and times (in) 35 and the dates and times (out) 36 may be numerical data measured by a timer that is set independently by the information processing apparatus 10.

A name 37 represents the name of a visited location. If the name of a location cannot be acquired from the map information, the name 37 can be left blank.

A type 38 represents the type of a visited location (land use type). If the type cannot be acquired from the map information, the type 38 can be left blank.

Note that geodata may include information about the addresses corresponding to the LIDs 32.

Note that the geodata acquisition unit 102 may acquire geodata generated by the user device 11. Also in this case, the geodata generated by the user device 11 includes the data shown in FIG. 3. That is, the user device 11 generates location information, dates and times (in) and dates and times (out) based on position data generated by positioning calculation and predetermined map information, as geodata including these data. The user device 11 can send geodata to the information processing apparatus 10 each time the user has stayed in any location for a certain period of time. The geodata acquisition unit 102 of the information processing apparatus 10 can assign an LID 32 to the position data (latitude and longitude) acquired from the user device 11.

The geodata acquisition unit 102 stores the acquired geodata in the data storage unit 120 as the geodata 121.

The user feature acquisition unit 103 acquires, from each of the user devices 11-1 to 11-N, a factual feature (factual information) (hereinafter referred to as a user feature) about the user device or the user. Similar to position data, a user ID is associated with the user feature. The user features are features (information) based on facts actually or objectively obtained from the user devices or the users. For example, the user feature acquisition unit 103 can directly acquire the user features from the user devices 11. Also, the user feature acquisition unit 103 can acquire the user features as information registered with a web service by the users of the user devices 11.

The user features include IP addresses of the user devices, the addresses of the users or the names of the users, the numbers of credit cards owned by the users, demographic information of the users (demographic user attributes such as sex, age, residential area, occupation, and family composition), and the like. Also, the user features may include registration numbers and registration names used when using a predetermined web service. Also, the user features may include information relating to a call history, a delivery address other than the address of the user for a product at the time of using the predetermined web service, a use status during use of the predetermined web service, a use history, a search history, and points that can be accumulated through use of a service. Thus, the user features can include any information, including information relating to the user device or the user, and information relating to use of a predetermined service through communication. In the present embodiment, although the user feature is a factual feature about the user, any information will suffice as long as it indicates the user's inclination.

The user feature acquisition unit 103 stores the acquired user features in the data storage unit 120 as the user features 122.

The user vector generation unit 104 generates three types of feature vectors based on the geodata 121 and the user feature 122, and combines these feature vectors to generate a user vector. The procedure for generating user vectors will be described below.

The sequence vector generation unit 105 uses the position data acquired by the position data acquisition unit 101 to generate a sequence vector representing a sequence of locations visited by the user. The procedure for generating sequence vectors will be described below.

The training unit 106 trains the next location prediction model 111 using the user vectors generated by the user vector generation unit 104 and the sequence vectors generated by the sequence vector generation unit 105. The training unit 106 stores the trained next location prediction model 111 in the learning model storage unit 110. The training processing by the training unit 106 will be described below.

The prediction unit 107 uses the trained next location prediction model 111 for any user to predict the next location that the user will visit. The processing for predicting the next location to visit will be described below.

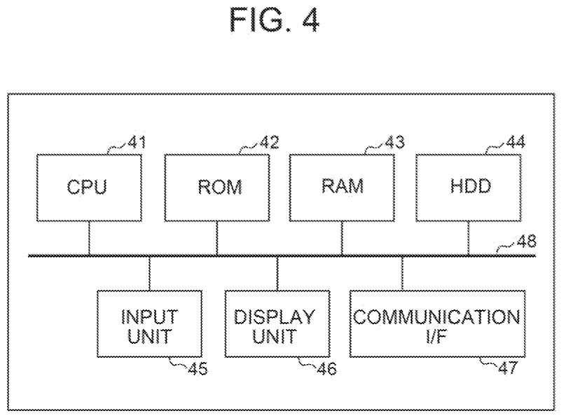

The output unit 108 outputs the result predicted by the prediction unit 107 (prediction result). The output unit 108 may also generate and output information relating to the next location any user will visit. The output can be any output processing, and may be output to an external device via a communication I/F (the communication I/F 47 in FIG. 4), or may be display on a display unit (the display unit 46 in FIG. 4).

Hardware Configuration of Information Processing Apparatus 10

FIG. 4 is a block diagram showing an example of a hardware configuration of the information processing apparatus 10 according to the present embodiment.

The information processing apparatus 10 according to the present embodiment can be implemented also on any one or more computers, mobile devices, or other processing platforms.

With reference to FIG. 4, an example is shown in which the information processing apparatus 10 is implemented on a single computer, but the information processing apparatus 10 according to the present embodiment may be implemented on a computer system including a plurality of computers. The plurality of computers may be connected so as to be capable of mutual communication through a wired or wireless network.

As shown in FIG. 4, the information processing apparatus 10 may include a CPU 41, a ROM 42, a RAM 43, an HDD 44, an input unit 45, a display unit 46, a communication I/F 47, and a system bus 48. The information processing apparatus 10 may include an external memory.

The CPU (Central Processing Unit) 41 performs overall control of operations in the information processing apparatus 10, and controls each constituent unit (42 to 47) via the system bus 48, which is a data transmission path.

The ROM (Read Only Memory) 42 is a non-volatile memory that stores control programs and the like needed for the CPU 41 to execute processing. Note that the program may also be stored in a non-volatile memory such as the HDD (Hard Disk Drive) 44 or an SSD (Solid State Drive), or an external memory such as a detachable storage medium (not shown).

The RAM (Random Access Memory) 43 is a volatile memory and functions as a main memory, a work area, and the like of the CPU 41. That is, during execution of processing, the CPU 41 executes various functional operations by loading necessary programs and the like from the ROM 42 to the RAM 43, and executing the programs and the like.

The HDD 44 stores various types of data, various types of information, and the like that are needed when the CPU 41 performs processing using a program. Also, the HDD 44 stores various types of data, various types of information, and the like obtained by the CPU 41 performing processing using a program or the like.

The input unit 45 is constituted by a keyboard or a pointing device such as a mouse.

The display unit 46 is constituted by a monitor such as a liquid crystal display (LCD). The display unit 46 may also function as a GUI (Graphical User Interface) due to being included in combination with the input unit 45.

The communication I/F 47 is an interface that controls communication between the information processing apparatus 10 and an external device.

The communication I/F 47 provides an interface with a network and executes communication with an external device via the network. Various types of data, various types of parameters, and the like are transmitted and received to and from the external device via the communication I/F 47. In the present embodiment, the communication I/F 47 may execute communication via a wired LAN (Local Area Network) or a dedicated line conforming to a communication standard such as Ethernet (registered trademark). However, the network that can be used in the present embodiment is not limited thereto, and may also be constituted by a wireless network. The wireless network includes a wireless PAN (Personal Area Network) such as Bluetooth (registered trademark), ZigBee (registered trademark), and UWB (Ultra Wide Band). The wireless network also includes a wireless LAN (Local Area Network) such as Wi-Fi (Wireless Fidelity) (registered trademark) and a wireless MAN (Metropolitan Area Network) such as WiMAX (registered trademark). Furthermore, the wireless network includes a wireless WAN (Wide Area Network) such as LTE/3G, 4G, and 5G. Note that it is sufficient that the network connects the devices such that communication is possible therebetween and is capable of communication, and the standard, scale, and configuration of communication is not limited to the above.

The function of at least some of the elements of the information processing apparatus 10 shown in FIG. 4 can be realized by the CPU 41 executing a program. However, the function of at least some of the elements of the information processing apparatus 10 shown in FIG. 4 may also be realized by an operation of dedicated hardware. In this case, the dedicated hardware operates based on control performed by the CPU 41.

Hardware Configuration of User Device 11

The hardware configuration of the user device 11 shown in FIG. 1 may be the same as that shown in FIG. 4. That is, the user device 11 can include the CPU 41, the ROM 42, the RAM 43, the HDD 44, the input unit 45, the display unit 46, the communication I/F 47, and the system bus 48. The user device 11 can display various types of information provided by the information processing apparatus 10 on the display unit 46 and perform processing corresponding to an input operation received from the user via the GUI (constituted by the input unit 45 and the display unit 46).

Procedure for Generating User Vector

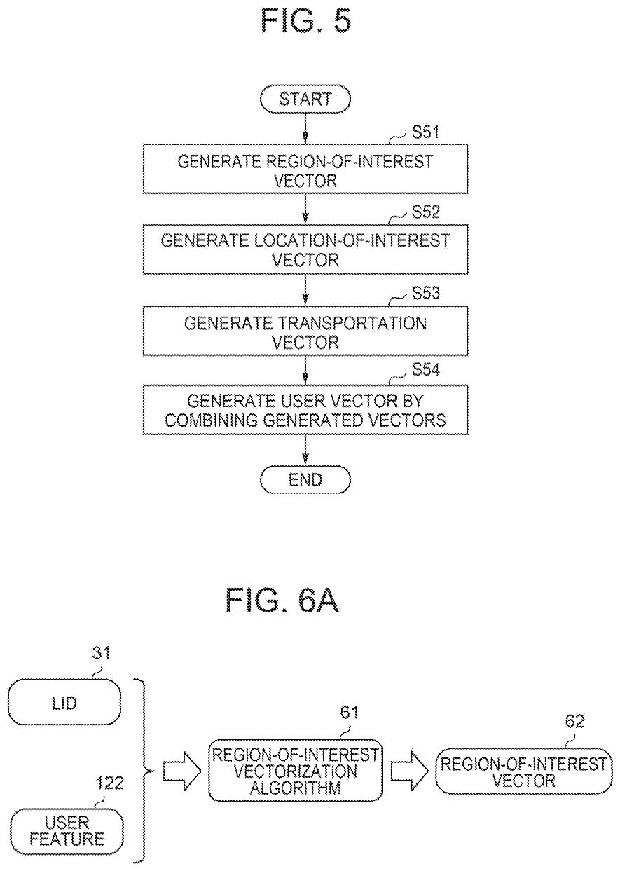

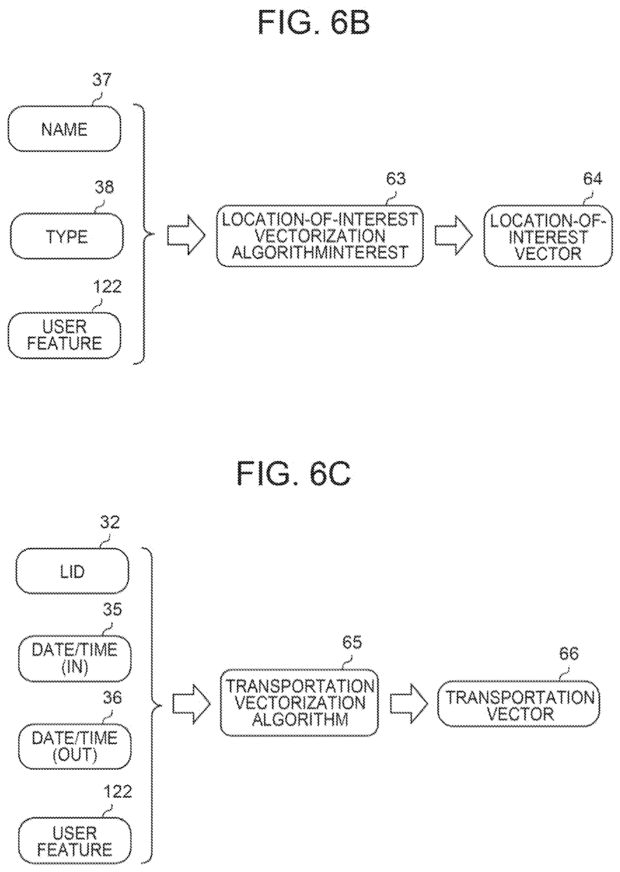

Next, a procedure for generating a user vector by the user vector generation unit 104 will be described with reference to FIGS. 5 and 6A to 6D. FIG. 5 is a flowchart showing the procedure for generating a user vector. In the present embodiment, the user vector generation unit 104 generates three types of feature vectors, i.e., a region-of-interest vector, a location-of-interest vector, and a transportation vector (a means-of-transportation vector) (steps S51 to S53). Next, the user vector generation unit 104 combines these feature vectors to generate a user vector (step S54). Note that the order of steps S51 to S53 is not limited to the order shown in FIG. 5. For example, these steps of the processing may be performed in a different order than shown in FIG. 5, or they may be performed simultaneously. Each step of the processing in FIG. 5 will be described below.

In step S51, the user vector generation unit 104 generates region-of-interest vectors. A region-of-interest vector is a vector that represents a geographical feature of the movement pattern of a user (region-of-interest). In particular, a region-of-interest vector is a common feature of locations (geographic areas) in a user's movement (path) or movement pattern. If a user 1 is acting in a specific geographic area, the region-of-interest vector for user 1 represents a feature of that specific area. Also, if the behavior of user 1 has a specific movement pattern, the region-of-interest vector represents a feature of the area corresponding to that movement pattern. FIG. 6A shows a conceptual diagram of a procedure for generating a region-of-interest vector.

First, the user vector generation unit 104 acquires the LIDs 32 for each user ID from the geodata 121, and generates a sequence of the LIDs 32, i.e., a sequence of the position data of the visited locations (which can include latitude and longitude, and information of the corresponding addresses). For example, if the user ID 31 is 001, information indicating L1→L2→L5 is generated as the sequence of LIDs 32.

Subsequently, the user vector generation unit 104 generates a region-of-interest vector 62 for each user ID using the generated sequence of the LIDs 32 and the user feature 122 according to a region-of-interest vectorization algorithm 61.

The region-of-interest vectorization algorithm 61 can be an algorithm based on NLP (Natural Language Processing), such as Doc2Vec, for understanding the area covered by the user (the area of influence exerted by the user). The region-of-interest vectorization algorithm 61 converts a sequence of LIDs 32 and the user feature 122 into a region-of-interest vector 62. That is, the region-of-interest vectorization algorithm 61 performs embedding and generates the region-of-interest vector 62 (embedding vector) based on the sequence of LIDs 32 and the user feature 122. Note that the region-of-interest vector 62 may also be generated using the dates and times (in) 35 and dates and times (out) 36 that correspond to the LIDs 32. In this case, the feature of the relationship between the dates and times (times) and the region-of-interest is also included in the region-of-interest vector 62.

In step S52, the user vector generation unit 104 generates a location-of-interest vector. A location-of-interest vector is a vector that represents a feature of the location of interest for a user through the locations the user has moved to (the visited locations). For example, locations of interest for the user are one or more specific locations that the user is interested in, or one or more POIs (Point of Interest). A location of interest for the user may be location information or the name of a location (for example, the name of a specific building or area). The location-of-interest vector differs from the above-described region-of-interest vector in that the former represents specific locations in which the user shows interest while the latter represents a geographical feature of the movement pattern (a feature of a larger area) of the user. FIG. 6B shows a conceptual diagram of a procedure for generating location-of-interest vectors.

The user vector generation unit 104 acquires, for each user ID, a name 37 and a type 38 from the geodata 121. If there are a plurality of LIDs 32 for the user ID, the user vector generation unit 104 acquires a plurality of names 37 and types 38.

Subsequently, the user vector generation unit 104 generates a location-of-interest vector 64 for each user ID using the names 37, the types 38, and the user features 122 according to a location-of-interest vectorization algorithm 63.

The location-of-interest vectorization algorithm 63 can be an algorithm based on text analysis (semantic analysis). The location-of-interest vectorization algorithm 63 converts the names 37, the types 38, and the user feature 122 to a location-of-interest vector 64. That is, the location-of-interest vectorization algorithm 63 performs embedding and generates the location-of-interest vector 64 (embedding vector) based on the names 37, the types 38, and the user feature 122. Note that the location-of-interest vector 64 may also be generated using the dates and times (in) 35 and dates and times (out) 36 that correspond to the LIDs 32. In this case, the feature of the relationship between the dates and times (times) and the location of interest is also included in the location-of-interest vector 64.

In step S53, the user vector generation unit 104 generates a transportation vector. A transportation vector is a vector that represents a feature of the transportation used by a user through the movement of the user (visited locations). FIG. 6C shows a conceptual diagram of a procedure for generating a transportation vector.

First, the user vector generation unit 104 acquires the LIDs 32 for each user ID from the geodata 121, and generates a sequence of the LIDs 32, i.e., a sequence of the position data on the visited locations. Similar to step S51, for example, if the user ID 31 is 001, information indicating L1→L2→L5 is generated as the sequence of LIDs 32. The user vector generation unit 104 also acquires, for each user ID, the dates and times (in) 35 and the dates and times (out) 36 from the geodata 121.

Subsequently, the user vector generation unit 104 generates a transportation vector 66 for each user ID using the generated sequence of the LIDs 32, the dates and times (in) 35 and the dates and times (out) 36, and the user feature 122 according to a transportation vectorization algorithm 65.

First, the transportation vectorization algorithm 65 calculates (derives) a movement feature between two LIDs 32, such as the speed, the acceleration, or the like of the user, based on each LID 32 of the sequence of LIDs 32, each date and time (in) 35, and each date and time (out) 36.

Also, the transportation vectorization algorithm 65 generates a route feature by mapping the route (path) between LIDs 32 of the sequence of LIDs 32 onto a predetermined map data. The map data includes, for example, a road network, a railroad network, and a bus route network. The road network is road information representing roads (every road on the ground that connects one location to another). The railroad network is information on a railroad map. The bus route network is information on a public bus route map. The bus route network may include information on a map of the routes of special buses. The road network, the railroad network, and the bus route network can be represented by lines representing roads, railroads, and bus routes, respectively. The transportation vectorization algorithm 65 generates a route feature, through mapping, that indicates which of a road, a railroad, or a bus the route between LIDs corresponds to.

Next, the transportation vectorization algorithm 65 predicts a transportation for the user based on the calculated movement feature and the generated route feature, and generates the transportation vector 66 (embedding vector) based on that transportation. For example, if the movement feature is a speed of between 15 m/s or more and 33 m/s or less, and the route feature is a road, the transportation vectorization algorithm 65 predicts that the transportation for the user will be a car, and generates the transportation vector 66 based on that transportation. For example, if the movement feature is a speed of between 1.4 m/s or more and the route feature is a road, the transportation vectorization algorithm 65 predicts that the transportation for the user will be walking, and generates the transportation vector 66 based on that transportation.

In step S54, the user vector generation unit 104 combines the vectors generated in steps S51 to S53 to generate a user vector. FIG. 6D shows a conceptual diagram of a procedure for generating user vectors. The user vector generation unit 104 combines, through a combination algorithm 67, the region-of-interest vector 62, the location-of-interest vector 64, and the transportation vector 66 generated in steps S51 to S53 to generate a user vector 68. For example, the combination algorithm 67 is configured as an auto-encoder to generate a user vector 68 in which the features represented by the region-of-interest vector 62, the location-of-interest vector 64, and the transportation vector 66 are combined.

Note that although the present embodiment describes an example in which a user vector 68 is generated from a region-of-interest vector 62, a location-of-interest vector 64, and transportation vector 66, a user vector 68 can also be generated from two types of vectors, namely, a region-of-interest vector 62 and a location-of-interest vector 64.

Training Processing by Training Unit 106

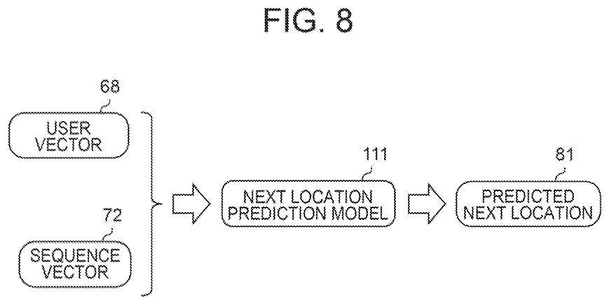

The training unit 106 trains the next location prediction model 111. The next location prediction model 111 is a learning model for machine learning to understand the sequence of the locations that a user has visited, and predict the next location that the user will visit. FIG. 8 shows a conceptual diagram of the next location prediction model 111. The next location prediction model 111 is configured to output data that indicates the next location for the user (the next location to visit) using the user vector 68 generated by the user vector generation unit 104 and the sequence vector 72 indicating the path of the user as the inputs.

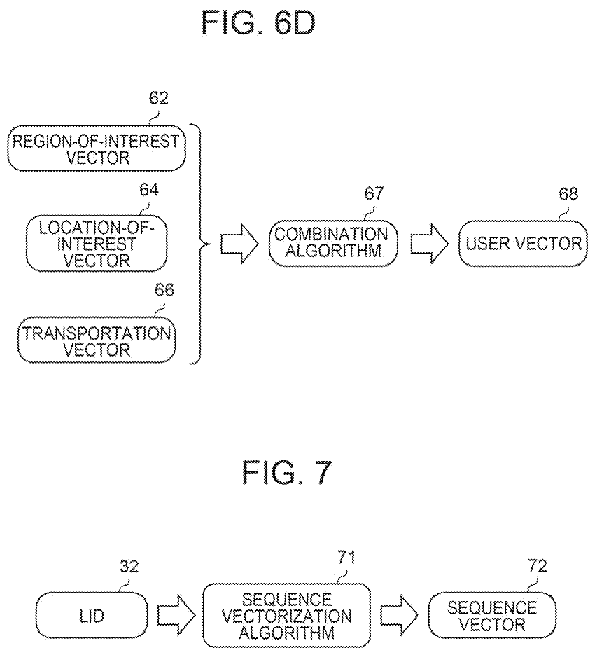

The sequence vector 72 is generated by the sequence vector generation unit 105. FIG. 7 shows a conceptual diagram of a procedure for generating sequence vectors. In the training stage, the user vector generation unit 105 acquires the LIDs 32 for each user ID from the geodata 121, and generates a sequence of the LIDs 32, i.e., a sequence of the position data on the visited locations. For example, if the user ID 31 is 001, a feature indicating L1-*L2 (behavioral history) is generated as the sequence of LIDs 32. If the user ID 31 is 001, the entire sequence of LIDs 32 is L1→L2→L5, but L5 is used as the correct data for training processing. The sequence vector generation unit 105 uses the sequence of LIDs 32 to generate the sequence vector 72 according to a sequence vectorization algorithm 71. The sequence vectorization algorithm 71 may be an algorithm based on any technique as long as it can generate, from the sequence of LIDs 32, a vector that represents a feature of that sequence.

The training unit 106 inputs the user vector 68 and the sequence vector 72 to the next location prediction model 111, and compares the data indicating the output next location with the next location given as the correct data to train the next location prediction model 111. For example, if the user ID 31 is 001, the training unit 106 inputs the user vector 68 corresponding to the user and the sequence vector 72 representing L1-*L2 to the next location prediction model 111, compares the output data with L5, which is the correct data, and uses the result of the comparison to train the next location prediction model 111. This training processing is repeated on the data of the plurality of users included in the geodata 121. Through such training processing, a pattern of locations visited by a user having a certain user feature, i.e., a behavioral pattern, is learned.

Processing for Predicting the Next Location the User Will Visit

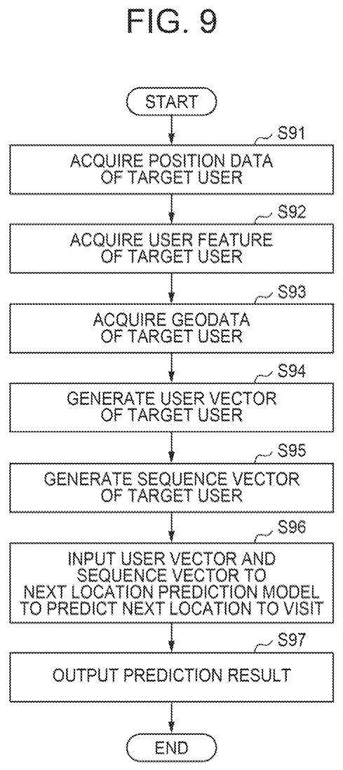

The information processing apparatus 10 uses a trained next location prediction model 111 to predict the next location that a user will visit. FIG. 9 shows a flowchart showing a procedure for predicting the next location that a user will visit. The processing may be started, for example, when a user whose next visiting location is to be predicted (hereinafter referred to as a target user) is specified in the information processing system. Alternatively, this processing may be started, for example, when the information processing apparatus 10 decides on a target user according to a predetermined setting, or may be started by some other trigger.

In step S91, the position data acquisition unit 101 acquires the position data on the target user (including the latitude and longitude).

In step S92, the user feature acquisition unit 103 acquires the user feature of the target user.

In step S93, the geodata acquisition unit 102 uses the position data of the target user acquired in step S91 to generate and acquire geodata on the target user. As shown in FIG. 3, the geodata may include position data, location information, dates and times (in) and dates and times (out) of the visited locations. Note that the geodata acquisition unit 102 may acquire geodata generated by the target user.

In step S94, the user vector generation unit 104 uses the geodata of the target user acquired in step S93 and the user feature acquired in step S92 to generate a user vector. The procedure for generating a user vector has been described above with reference to FIGS. 5 and 6A to 6D.

In step S95, the sequence vector generation unit 105 generates a sequence vector from the geodata of the target user acquired in step S93. The procedure for generating a sequence vector has been described above with reference to FIG. 7.

In step S96, the prediction unit 107 inputs the user vector of the target user generated in step S94 and the sequence vector of the target user generated in step S95 to the next location prediction model 111 to predict the next location that the target user will visit. The trained next location prediction model 111 predicts the next location that the target user will visit based on the behavioral pattern of a user having a user feature similar to that of the input target user, and output data that indicates that next location (see FIG. 8). The output data indicating the next location is shown, for example, as an LID, and the prediction unit 107 predicts that the location corresponding to that LID is the next location the user will visit.

In step S97, the output unit 108 outputs the prediction result generated in step S96. For example, if the prediction unit 107 predicts LID=L3 as the next location to visit, the prediction unit 107 generates and outputs information indicating the location of L3 as the prediction result. In this case, the output unit 108 may also generate and output an advertisement relating to the predicted next location to visit. For example, with reference to FIG. 3, as LID=L3 is a convenience store named GHI Mart, the output unit 108 may generate and provide an advertisement for GHI Mart to the target user. As such, the advertisement can provide useful information for the target user if the user actually goes to the GHI Mart.

In this way, the information processing apparatus according to the present embodiment generates a user feature (information indicating the user's inclination) and a user vector that includes a feature relating to the movement of the user. Then, the information processing apparatus uses the user vector and the path of the user's movement (the sequence of LIDs) to train the next location prediction model for predicting the next location that the user will visit. Since the user vector includes features related to locations and areas of interest to the user, accurate learning of the user's behavior pattern in relation to the user feature is possible.

Furthermore, the information processing apparatus according to the present embodiment is configured to use a trained next location prediction model to predict the next location that a user (target user) will visit. By using this model, it is possible to use the features of the movement of other users having user features similar to that of the target user to predict the next location the target user will visit. Moreover, by using this model, even if data on the behavior of the target user possessed by the information processing apparatus is not plentiful (i.e., sparse), the features of the movement (behavioral history and the like) of users having similar features can be used to predict the behavior of the target user.

Moreover, since it is possible to predict the next location the target user will visit, an advertisement for the next location to visit can be created and presented to the target user. This not only allows the target user to receive useful information, but improvement in the effectiveness of advertising to the target user can also be expected.

It should be noted that although a specific embodiment has been described above, the embodiment is merely an example, and is not intended to limit the scope of the present invention. The devices and methods described in the present specification can be embodied in forms other than those described above. Also, the above-described embodiment can be subjected to omission, replacement, and modification as appropriate without departing from the scope of the present invention. Modes obtained through such omission, replacement, and modification are encompassed in the description of the claims and the range of equivalency thereto, and belong to the technical scope of the present invention.

### EMBODIMENTS OF THE PRESENT DISCLOSURE

The present disclosure includes the following embodiments.

[1] An information processing apparatus comprising: a position data acquisition unit configured to acquire data on positions of a user accompanying movement of the user; a feature acquisition unit configured to acquire a user feature representing a feature of the user; a user vector generation unit configured to generate a user vector representing a feature of the movement of the user based on the position data and the user feature; a sequence vector generation unit configured to generate a sequence vector representing a sequence of locations visited by the user based on the position data; and a prediction unit configured to predict a next location that the user will visit based on the user victor and the sequence vector through machine learning.

[2] The information processing apparatus according to [1], wherein based on the position data and the user feature, the user vector generation unit generates a region-of-interest vector that represents a geographical feature of a pattern of the movement of the user, and a location-of-interest vector that represents a feature of a location of interest for the user through the locations that the user has moved to, and generates the user vector by combining the region-of-interest vector and the location-of-interest vector.

[3] The information processing apparatus according to [1], wherein based on the position data and the user feature, the user vector generation unit generates a region-of-interest vector that represents a geographical feature of a pattern of the movement of the user, a location-of-interest vector that represents a feature of a location of interest for the user through the movement of the user, and a transportation vector representing a feature of a transportation used by the user through the movement of the user, and generates the user vector by combining the region-of-interest vector, the location-of-interest vector, and the transportation vector.

[4] The information processing apparatus according to [2] or [3], wherein the user vector generation unit uses the sequence of the locations visited by the user based on the position data and the user feature to generate the region-of-interest vector.

[5] The information processing apparatus according to [2] or [3], wherein the user vector generation unit uses names of the locations visited by the user based on the position data, land use types of the locations, and the user feature to generate the location-of-interest vector.

[6] The information processing apparatus according to any one of [1] to [5], further comprising a training unit configured to train a learning model for the machine learning, wherein the training unit uses the user vectors and the sequence vectors for a plurality of other users different from the user to train the learning model.

[7] The information processing apparatus according to any one of [1] to [6], wherein the user feature is a factual feature of the user.

[8] The information processing apparatus according to any one of [1] to [7], further comprising a provision unit configured to generate and provide to the user an advertisement relating to information of the location predicted by the prediction unit.

[9] An information processing apparatus comprising: acquiring data on positions of a user accompanying movement of the user; acquiring a user feature representing a feature of the user; generating a user vector representing a feature of the movement of the user based on the position data and the user feature; generating a sequence vector representing a sequence of locations visited by the user based on the position data; and predicting a next location that the user will visit based on the user victor and the sequence vector through machine learning.

[10] An information processing program for causing a computer to execute information processing, the program causing the computer to execute: position data acquisition processing for acquiring data on positions of a user accompanying movement of the user; feature acquisition processing for acquiring a user feature representing a feature of the user; user vector generating processing for generating a user vector representing a feature of the movement of the user based on the position data and the user feature; sequence vector generation processing for generating a sequence vector representing a sequence of locations visited by the user from the position data; and prediction processing for predicting a next location that the user will visit based on the user victor and the sequence vector through machine learning.

1. An information processing apparatus comprising:
a position data acquisition unit configured to acquire data on positions of a user accompanying movement of the user;
a feature acquisition unit configured to acquire a user feature representing a feature of the user;
a user vector generation unit configured to generate a user vector representing a feature of the movement of the user based on the position data and the user feature;
a sequence vector generation unit configured to generate a sequence vector representing a sequence of locations visited by the user based on the position data; and
a prediction unit configured to predict a next location that the user will visit based on the user victor and the sequence vector through machine learning.

2. The information processing apparatus according to claim 1, wherein based on the position data and the user feature, the user vector generation unit generates a region-of-interest vector that represents a geographical feature of a pattern of the movement of the user, and a location-of-interest vector that represents a feature of a location of interest for the user through the locations that the user has moved to, and generates the user vector by combining the region-of-interest vector and the location-of-interest vector.

3. The information processing apparatus according to claim 1, wherein based on the position data and the user feature, the user vector generation unit generates a region-of-interest vector that represents a geographical feature of a pattern of the movement of the user, a location-of-interest vector that represents a feature of a location of interest for the user through the movement of the user, and a transportation vector representing a feature of a transportation used by the user through the movement of the user, and generates the user vector by combining the region-of-interest vector, the location-of-interest vector, and the transportation vector.

4. The information processing apparatus according to claim 2, wherein the user vector generation unit uses the sequence of the locations visited by the user based on the position data and the user feature to generate the region-of-interest vector.

5. The information processing apparatus according to claim 2, wherein the user vector generation unit uses names of the locations visited by the user based on the position data, land use types of the locations, and the user feature to generate the location-of-interest vector.

6. The information processing apparatus according to claim 1, further comprising
a training unit configured to train a learning model for the machine learning,
wherein the training unit uses the user vectors and the sequence vectors for a plurality of other users different from the user to train the learning model.

7. The information processing apparatus according to claim 1, wherein the user feature is a factual feature of the user.

8. The information processing apparatus according to claim 1, further comprising
a provision unit configured to generate and provide to the user an advertisement relating to information of the location predicted by the prediction unit.

9. An information processing apparatus comprising:
acquiring data on positions of a user accompanying movement of the user;
acquiring a user feature representing a feature of the user;
generating a user vector representing a feature of the movement of the user based on the position data and the user feature;
generating a sequence vector representing a sequence of locations visited by the user based on the position data; and
predicting a next location that the user will visit based on the user victor and the sequence vector through machine learning.

10. A non-transitory computer readable medium storing a computer program for causing a computer to execute processing comprising:
position data acquisition processing for acquiring data on positions of a user accompanying movement of the user;
feature acquisition processing for acquiring a user feature representing a feature of the user;
user vector generating processing for generating a user vector representing a feature of the movement of the user based on the position data and the user feature;
sequence vector generation processing for generating a sequence vector representing a sequence of locations visited by the user from the position data; and
prediction processing for predicting a next location that the user will visit based on the user victor and the sequence vector through machine learning.
